(19) United States
(12) Patent Application Publication
(10) Pub. No.: US 2005/0229676 A1
(43) Pub. Date: Oct. 20, 2005

(54) Exhaust gas oxygen sensor

(76) Inventor: Patrick T. Moseley, Chapel Hill, NC (US)

Correspondence Address: JAMES C. WRAY, 1493 CHAIN BRIDGE ROAD, SUITE 300, MCLEAN, VA, 22101, US

(21) Appl. No.: 10/524,503

(22) PCT Filed: Aug. 14, 2003
(86) PCT No.: PCT/US03/25481

§ 371 Date: Feb. 14, 2005

(30) Foreign Application Priority Data
Aug. 14, 2002 (US) 60402948

(51) Int. Cl. G01N 27/02

(52) U.S. Cl. 73/23.31; 73/31.05; 436/160; 438/49; 257/414

(57) ABSTRACT

The present invention identifies a formulation for a subgroup of perovskite structure oxides that overcomes the outstanding problems for oxygen sensing in a combustion environment. The sub group has a formula ABOₓ where A is a large 3-valent ion, such as Pr³⁺, B is a transition metal ion, which is substituted to a small degree by tungsten (which has a stable valence of 6), and x indicates that the oxide can sustain a variable oxygen stoichiometry. A preferred general formulation is a single-phase perovskite structure AB_{1-y}W_{y}Oₓ where y preferably lies between 0.03 and 0.15, more preferably between 0.05 and 0.10 and where x is close to 3. Preferred examples of compositions that can achieve these advantages include, but are not limited to, PrFe_{0.95}W_{0.05}Oₓ and LaFe_{0.95}W_{0.05}Oₓ.

### BACKGROUND OF THE INVENTION

Semiconductor gas sensors function by offering a change in electrical resistance in response to a shift in the local concentration of the gas of interest. In general the resistance of the sensor is some function of the concentration of the target gas.

Oxides with the perovskite type crystal structure and general formula ABO₃, where A represents a large main group ion, and B represents a transition metal, are particularly suitable for use as oxygen sensors. This is because the perovskite structure is very robust and allows a considerable variability in oxygen content without breakdown in structure. Early examples of compositions proposed for the application were SrTiO₃ and BaTiO₃.

The problem of temperature sensitivity with perovskite structures was overcome by the selection of a group of perovskite structure compositions that exhibited constant values of conductivity (in an atmosphere of constant oxygen partial pressure) over a considerable range of temperature. U.S. Pat. Nos. 4,454,494 and 4,677,414 describe this desirable property for a group of alkaline earth ferrates (for example, Sr Feo₃₋ₓ and Ba FeO₃₋ₓ) in which the iron component was partially substituted by other transition metals whose primary valence states were 4 or 5.

Subsequently U.S. Pat. No. 5,397,541 laid claim to a very wide range of perovskite structure oxides as potential sensors for oxygen. At least one of the examples in U.S. Pat. No. 5,397,541 (SrFe_{0.9}Ti_{0.1}O_{y}) lies within the range of compositions covered by U.S. Pat. No. 4,454,494.

Needs exist for improved methods and apparatus for sensing that are selective for a particular gas, without interference from other components of the atmosphere, including moisture (relative humidity), and/or changes in temperature.

### SUMMARY OF THE INVENTION

In general the resistance of the sensor is some function of the concentration of the target gas. Two general mechanisms can be exploited to achieve this concentration dependence on gas composition. A present invention engineers a response, which is selective for a particular gas, without interference from other components of the atmosphere, including moisture (relative humidity), and/or changes in temperature.

The mechanism of semiconductor gas sensors operating at lower temperatures, generally within the range 200-500° C., involves reactions of molecules of the target gas with chemisorbed species on the surface of the semiconductor, which is usually a metal oxide, and results in a change in near-surface charge carrier density. Materials functioning through this mechanism can be employed in the detection and monitoring of either reducing gases, for example but not limited to hydrogen, carbon monoxide, methane, etc., or oxidizing gases, for example but not limited to nitric oxide, chlorine, ozone, etc., in ambient air. This response mechanism involves no change in the bulk composition of the semiconducting oxide.

Within a somewhat higher temperature range, approximately 500-700° C., a family of semiconducting oxides MOₓ, where M represents either a transition metal or a combination of metals, one of which is a transition metal, can be used for monitoring oxygen partial pressure. In this case the bulk stoichiometry does change because the oxygen content of the material (the value of x) equilibrates with the prevailing oxygen partial pressure. Changes in the value of x are compensated by changes in the ratio of the valence states of the transition metal component of M. The present sensor preferably operates via this second mechanism.

These and further and other objects and features of the invention are apparent in the disclosure, which includes the above and ongoing written specification, with the drawings.

### BRIEF DESCRIPTION OF THE DRAWINGS

FIG. 1 is a graph showing a schematic of a variation of conductivity of perovskite structure oxides with temperature and oxygen partial pressure.

FIG. 2 is a graph showing resistance versus time for a sensor at 600° C.

### DETAILED DESCRIPTION OF THE PREFERRED EMBODIMENTS

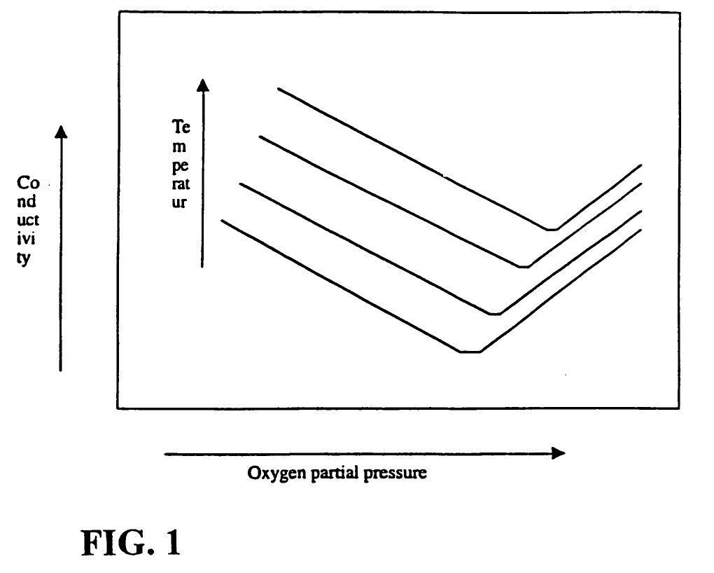

In general, the conductivity of materials, such as SrTiO₃ and BaTiO₃, follows the form shown schematically in FIG. 1. Through the region of low partial pressure the conductivity falls as the oxygen partial pressure increases. It passes through a minimum value and then increases as the partial pressure continues to rise. The material is thus exhibiting n-type behavior at low oxygen partial pressure and p-type behavior over the higher oxygen partial pressure range. Both the oxygen partial pressure and the temperature generally influence the conductance of these oxides. This is shown by reference to the series of curves one above the other in FIG. 1. These correspond to increasing temperatures moving up the FIG. 1.

A result of the minimum value present in each curve is that most measurements of conductance of the oxygen sensor are capable of two different interpretations because there are two values of oxygen partial pressure that could give rise to the same conductance value. Such ambiguity is likely to reduce the usefulness of the sensor unless it can be avoided.

An important feature of the dependence of conductivity on oxygen partial pressure, seen in FIG. 1, is that in the p-type range to the right of FIG. 1, the isothermal data lines are very much closer together than in the n-type range on the left of FIG. 1. In other words the temperature dependence of conduction is considerably less-in the p-type than in the n-type range. Operation in the p-type range facilitates the task of eliminating temperature effects from the oxygen partial pressure measurements.

One of the major applications foreseen for oxygen sensors is in the monitoring and control of combustion processes and it transpires that, unfortunately, when the fuel in use contains even a small amount of sulfur, so that the atmosphere in which the sensor operates includes sulfur oxide gases, perovskite oxides structured around alkaline earth ions, for example Sr and Ba, undergo a permanent degradation due to the formation of stable sulfates, for example SrSO₄, BaSO₄, and quickly fail.

The present invention identifies a formulation for a subgroup of perovskite structure oxides that overcomes the outstanding problems for oxygen sensing in a combustion environment. The sub group has a formula ABOₓ where A is a large 3-valent ion, such as Pr³⁺, B is a transition metal ion, which is substituted to a small degree by tungsten, which has a stable valence of 6, and x indicates that the oxide can sustain a variable oxygen stoichiometry.

A preferred general formulation is a single-phase perovskite structure AB_{1-y}W_{y}Oₓ where y preferably lies between 0.03 and 0.15, more preferably between 0.05 and 0.10 and where x is close to 3.

Preferred examples of compositions that can achieve these advantages include, but are not limited to, PrFe_{0.95}W_{0.05}Oₓ and LaFe_{0.95}W_{0.05}Oₓ.

A first advantage of this invention is that, lacking an alkaline earth, the compositions are not prone to the formation of sulfates as stable as SrSO₄ and BaSO₄, and therefore can be used in atmospheres where there is some contamination by sulfur gases.

A second advantage is that, with a minimum amount of doping on the B-site, the minimum in the conductance-oxygen partial pressure plot can be driven far in the low oxygen partial pressure direction, as seen to the left in FIG. 1, allowing the p-type range of the oxide to be used over the whole range of oxygen partial pressure of interest in combustion control. This is achieved because the replacement of iron on the B-site by an ion of higher valence invests the oxide with a more predominantly p-type characteristic down to lower oxygen partial pressures.

The use of a 6-valent ion, with nominally 3 excess positive charges over the ferric ion per substitution, is more effective than the use of 4-valent or 5-valent ions that have 1 or 2 excess positive charges respectively. Thus the required shift to p-type characteristic can be achieved with a lower level of doping on the B-site. The result is that the ambiguity in the interpretation of conductance measurements is eliminated for the range of partial pressure of interest.

### EXAMPLE

Stoichiometric amounts of constituent oxides La₂O₃, Fe₂O₃ and WO₃ sufficient to prepare approximately 20 grams of La_{1.0}Fe_{0.95}W_{0.05}O₃ were mixed thoroughly with 100 grams NaHCO₃ and heated in an alumina crucible to 900° C. for 10 hours. The mixture was cooled to room temperature and washed with distilled water to remove all traces of sodium compounds. XRD confirmed that the product had a perovskite crystal structure.

The powder was ground and then dispersed in an organic vehicle and screen-printed over gold interdigitated electrodes on an alumina substrate to give an oxide layer thickness of 50 microns. The substrate, which had previously been equipped with a platinum resistance heater printed on the reverse, was fired in a belt furnace at 980° C. to give a brown colored sensor.

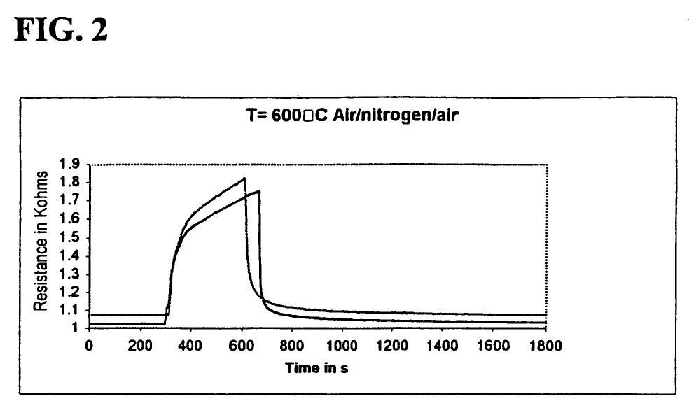

When exposed to a change in pO₂ by switching the atmosphere from air (20% oxygen) to pure nitrogen (0% oxygen), with the sensor at 600° C. a resistance increase resulted, as expected for a p-type semiconducting oxide, see FIG. 2, which shows duplicate responses.

The sensor, still at 600° C., was then exposed to an atmosphere containing 100 ppm H₂S for 5 minutes and then returned to air. After 5 minutes the resistance had returned to within about 10% of its original value indicating that the device had not been poisoned by exposure to the sulfur-containing gas.

A preferred method of preparation of the sensor material comprises reacting starting material oxides in stoichiometric proportions in a molten salt, yielding a powder, screen-printing the powder on a substrate, forming a microstructure, and forming the sensor.

A preferred method of sensing combustion status (fuel-rich or fuel-lean) of an atmosphere of combustion gases comprises contacting the sensor material with the atmosphere, sensing change in conductance, resistance, capacitance and/or impedance in the sensor material, and monitoring and controlling combustion processes responsive to the change sensed in the sensor material.

While the invention has been described with reference to specific embodiments, modifications and variations of the invention may be constructed without departing from the scope of the invention.

1. A gas sensor for monitoring and controlling combustion processes comprising a sensor material of a perovskite structure oxide of formula ABOₓ, wherein A is a large 3-valent ion, wherein B is a transition metal ion substituted to a small degree by tungsten, and wherein x denotes a variable oxygen stoichiometry.

2. The sensor of claim 1, wherein the perovskite formula is AB_{1-y}W_{y}Oₓ.

3. The sensor of claim 2, wherein y is in a range between 0.03 and 0.15.

4. The sensor of claim 3, wherein y is in a range between 0.05 and 0.10.

5. The sensor of claim 2, wherein x is about 3.

6. The sensor of claim 2, wherein the perovskite structure is PrFe_{0.95}W_{0.05}Oₓ.

7. The sensor of claim 2, wherein the perovskite structure is LaFe_{0.95}W_{0.05}Oₓ.

8. The sensor of claim 1, wherein the perovskite structure does not form stable sulfates in environments contaminated by sulfur.

9. The sensor of claim 1, wherein minimum doping on the B-site provides a required range of oxygen partial pressure operation.

10. The sensor of claim 9, further comprising a 6-valent ion for doping on the B-site.

11. The sensor of claim 10, wherein the 6-valent ion enables a p-type range of the perovskite structure for use over a range of oxygen partial pressures of interest for monitoring and controlling combustion processes.

12. A method of preparation of the sensor material of claim 2, comprising reacting starting material oxides in stoichiometric proportions in a molten salt, yielding a powder, screen-printing the powder on a substrate, forming a microstructure, and forming the sensor.

13. A method of sensing combustion status of an atmosphere of combustion gases comprising contacting the sensor material as described in claim 2 with the atmosphere, sensing change in conductance, resistance, capacitance and/or impedance in the sensor material, and monitoring and controlling combustion processes responsive to the change sensed in the sensor material.
